(19) United States
(12) Patent Application Publication
(10) Pub. No.: US 2010/0017832 A1
(43) Pub. Date: Jan. 21, 2010

(54) NETWORK DIGITAL TELEVISION MIDDLEWARE

(76) Inventor: Guofu Wang, Beijing (CN)

Correspondence Address: RATNERPRESTIA, P.O. BOX 980, VALLEY FORGE, PA, 19482, US

(21) Appl. No.: 12/304,375

(22) PCT Filed: Jun. 12, 2007
(86) PCT No.: PCT/CN2007/001844

§ 371 Date: Sep. 2, 2009

(30) Foreign Application Priority Data
Jun. 12, 2006 (CN) 200610092708.X

(51) Int. Cl. H04N 7/173

(52) U.S. Cl. 725/109

(57) ABSTRACT

A digital television middleware, comprising: an application program description information finding unit for requesting application program description information from a first network and a second network; an application program description information converting unit for converting the received application program description information for the second network into description information in a format of an application program information table (AIT) which can be used by the first network; and an AIT table buffering unit for buffering the converted description information so as to download the requested application program description information for the second network used by the first network.

### BACKGROUND OF THE INVENTION

1. Field of Invention

The present invention relates to a digital video broadcasting (DVB) television middleware, and more particularly, to a digital television middleware constructed on a network combining an IP network and a DVB network, a method and a receiver (set-top-box) using the digital television middleware.

2. Description of Prior Art

European digital television standard is digital video broadcasting (DVB). From 1995, standards for digital television terrestrial broadcasting (DVB-T), digital television satellite broadcasting (DVB-S) and digital television cable broadcasting (DVB-C) were issued sequentially in Europe. European digital television preferably considers the satellite channel, and uses the QPSK modulation. European terrestrial broadcasting digital television uses the COFDM modulation with a bandwidth of 8 MHz. European cable digital television uses the QAM modulation. Presently, limited by the conditions, most DVB digital video broadcasting are unidirectional. That is, there is only the broadcasting from the providers, but there is no return back channel.

With the continuous development of information communication techniques, in particularly, IP techniques, the Internet is widely used. Network television, referred to as IPTV, which is a novel service combining the traditional telecommunication and the traditional broadcasting television services comes into view.

IPTV is one of the development trends for digital television, which transmits the digital television programs based on the IP infrastructures (for example, Internet). If the access network bandwidth within the last one mile can be solved, i.e., the bandwidth is large enough, IPTV may essentially overcome the defect of the traditional DVB digital television in the unidirectional transmission, and facilitate the development of interactive applications based on the digital television. It also facilitates the combination of telecommunication, television and computer communication networks. With the development and popular use of wideband access network techniques such as local area wideband, xDSL and FTTH, the bandwidth will not be the key problem obstructing the IPTV application.

Multimedia home platform (MHP) is defined by European DVB organization. MHP defines the interface standard between the interactive applications and the terminal devices. In February, 2000, DVB organization issues MHP version 1.0, and the latest one is version 1.1. Based on MHP 1.0.3, Globally Executable MHP (GEM) is defined. Currently, MHP has been used in some countries, and has been directly defined as their national standards in some countries. Open cable application platform (OCAP) is a cable television middleware standard defined by CableLabs according to GEM, which has been used as their national standards in U.S.A and Korea. Furthermore, there is also an ISDB standard used in Japan.

MHP mainly defines an overview structure of a set-top-box middleware, transport protocols, content formats, JAVA virtual machine and DVB-J APIs, security, details of respective layers, application states and performances, and auto-start of the applications, and it also defines specific application signaling. MHP is defined as three layers, a resource layer, a system software layer and an application layer. Typically, the resource layer includes MPEG processing, I/O devices, CPU, storage and graphic systems. The system software layer provides an abstract visual platform for the application layer, and manages MHP and the applications thereon by executing one application manager (also referred to as “navigator”).

The core of MHP, i.e., the system software is substantially a middleware. However, different from other middleware, MHP middleware is not a private middleware but an open and uniform middleware. MHP standard only defines some application program interfaces (APIs), but does not propose the method for implementing MHP. Therefore, the detail schemes for implementing MHP are mainly provided by middleware manufacturers and set-top-box manufacturers. Some software packages provide general APIs for that platform. MHP application may access the platform through these specified APIs. There is needed a mapping between the APIs and the lower layers of resources and system software.

That is, the middleware is a portion located between the real-time operation system within the digital television set-top-box and the application programs, which is transplantable, platform independent and present in a form of API, and the whole set of the APIs is stored in a flash memory FLASH in the set-top-box. The function of the middleware is to provide the basic and general functions of the set-top-box to the set-top-box manufacturers in a form of the APIs, and to make the application programs of the middleware run on a set-top-box which installs the middleware in a fashion independent from the particular set-top-box.

In MHP, the signaling information (application signaling) of the application programs is transmitted through an application information table (AIT). The AIT table includes respective application identifiers and descriptors associated with the application programs, for example, application program name descriptor, application icon descriptor and transport protocol descriptor, in which the transport protocol descriptor responds for describing the carrier medium and download protocol of the application program.

Middleware is defined based on the unidirectional DVB network, and thus can not be directly applied into an IP-based bidirectional digital television network or a hybrid network of DVB network and IP network, or the facilities of IP bidirectional network can not be well used. For example, the AIT and application download method can not be performed on the IP bidirectional network with directly using the traditional manners.

As described above, although middleware MHP (referred to as “middleware” hereinafter) was proposed for the unidirectional digital television network, some mechanisms are also based on MPEG TS stream definition and transmission, for example, the AIT and application program transmission manners DSMCC/OC/DC. However, this does not mean that the middleware is not suitable for IP-based bidirectional digital television network. Because MHP is a Java-based API interface for a digital television receiver, it can be used on different platforms. Additionally, one of the objects to propose the MHP standards is to provide an interactive bidirectional application based on the digital television. Therefore, MHP is more suitable for IPTV, and may be better developed in the IPTV environment.

### SUMMARY OF THE INVENTION

An object of the present invention is to provide a network digital television middleware which is capable of eliminating a different between an application program from a DVB network and an application program from an IP network for a user, transparently accessing the application programs, and receiving description information of digital interactive contents on at least one of the IP network and the DVB network, converting it into an application information table inside the middleware and buffer the table for user's usage.

The present invention also provides a digital video interactive system including such a receiver (a set-top-box).

According to an aspect of the present invention, there is provided a digital television middleware, comprising: an application program description information finding unit for requesting application program description information from a first network and a second network; an application program description information converting unit for converting the received application program description information for the second network into the description information in a format of an application program information table (AIT) which can be used by the first network; an AIT table buffering unit for buffering the converted description information so as to download the requested application program description information for the second network which can be used by the first network.

According to another aspect of the present invention, there is provided a method for interacting in a digital television network combining a first network and a second network, comprising the steps of: receiving a message contained in a multicast group, and providing said message to an application program description information finding unit in a digital television middleware; converting by an application program description information converting unit, application program description information based on the second network into description information into application program description information capable to be used by the first network, and newly generating a piece of application program description information (AIT); and storing the newly generated application program description information into an AIT table buffering unit.

The present invention further provides a set-top-box using the digital television middleware.

According to the present invention, the set-top-box receiver may access the middleware application programs from any of the IP network and the DVB network, which will greatly enhance the development and application of the middleware. Additionally, since the middleware is platform independent, it can be used in a hybrid network of the IP network and the DVB network, and may promote the development of IP digital televisions.

### BRIEF DESCRIPTION OF THE DRAWINGS

The above objects, advantages and features of the present invention will be apparent from the following detailed description on the preferred embodiments taken conjunction with the drawings in which:

FIG. 1 shows a frame structure of DVB digital television middleware according to the prior art;

FIG. 2 shows a frame structure of IP-based DVB digital television middleware according to the prior art; and

FIG. 3 shows a block diagram of IP-based DVB digital television middleware according to an embodiment of the present invention.

### DETAILED DESCRIPTION OF PREFERRED EMBODIMENTS

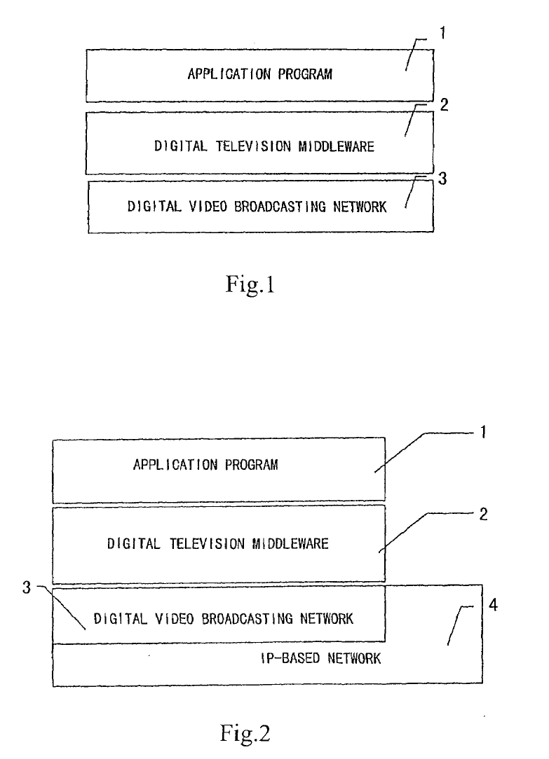

Now, the preferred embodiments of the present invention will be described by referring to the drawings. For clearly understanding the present invention, a frame structure of DVB digital television middleware according to the prior art will be firstly described by referring to FIG. 1 which shows a schematic diagram of the frame structure of the DVB digital television middleware according to the prior art.

As shown in FIG. 1, the architecture of the traditional DVB digital television middleware includes an application program 1 developed by using the middleware, a digital television middleware 2 and a digital television network construction 3. The digital television middleware 2 defines an application programming interface (API) by abstracting the functions of the digital television receiver, and also defines the interface between the receiving device and the connected network thereof, including service information, subtitle, common interface (for used by conditional access) and data broadcasting. In addition, an application program information table (AIT, also referred to as “application program notification description protocol”) and transport protocols for the application program files and the relevant data are also defined therein. The digital television network construction 3 may be aforementioned DVB-T, DVB-C, DVB-S, and the like. The contents to be transmitted thereby are all MPEG-2 TS packets. Since the middleware is platform independent, the application 1 developed by using the middleware is also platform independent, and thus may be run in any digital television receiving set-top-box having the middleware.

FIG. 2 shows a situation where a digital television middleware is directly applied to an IP-based digital television. In FIG. 2, reference number 4 denotes an IP-based network. DVB data packets are transmitted by using functional protocols such as RTP/RTCP via the IP network (that is, DVB over IP). At this time, the composition of the DVB structure is identical with that in FIG. 1. That is, it also includes the application program description information (AIT) and transmission data for the application program files and the relevant data, which is resulted in from directly applying the middleware to the IP digital television. However, in the IP network, there may be a lot of applications to be transmitted and applied not through the DVB but directly through the IP. Therefore, the situation shown in FIG. 2 is incomplete, can not completely use and exert the advantages and merits of IP network and middleware, and can not better extend the functions of the digital television receiving set-top-box.

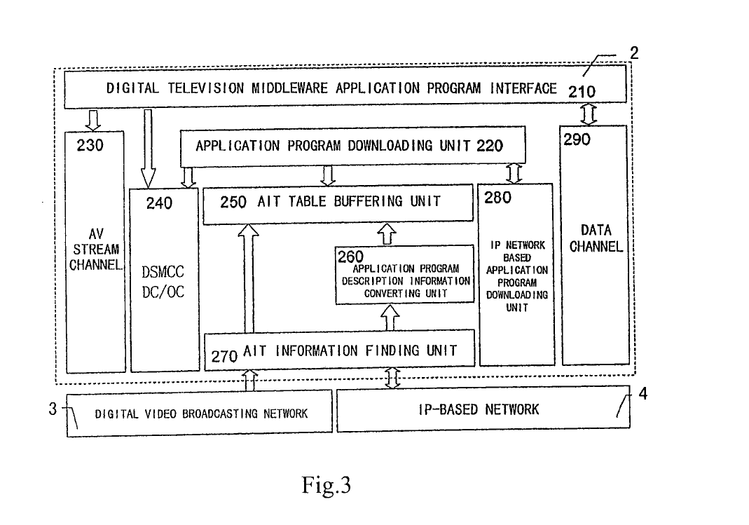

FIG. 3 represents one preferred embodiment of the present invention, which shows a block diagram of IP-based DVB digital television middleware. For simplicity, the application program 1 is not shown in FIG. 3, but only showing the middleware 2, the DVB 3 and the IP network 4. Different from the frame structure of the IP-based DVB digital television middleware shown in FIG. 2, the present invention does not apply the digital television middleware directly to the IP-based digital television, but connects it to the DVB digital television network 3 and the IP digital television network 2 through an AIT information finding unit respectively.

According to the preferred embodiment, the middleware includes a digital television (DTV) middleware application program interface 210, an application program downloading unit 220, an AV stream channel 230, a DSMCC DC/OC (Digital Storage Media Command and Control, Data Carousel/Object Carousel) unit 240, an AIT table buffering unit 250, an application program description information converting unit 260, an AIT information finding unit 270, an IP network based application program downloading unit 280, and an IP protocol based data channel 290.

According to the present invention, the middleware 2 may convert the application program information from the IP network 4 into a format of the AIT table which already exists in the DVB network, buffer it in the AIT table buffering unit 250, and then download the codes and essential data files of the application program from the IP network based application program downloading unit 280. Thus, DVB may execute these application programs.

Next, the operations of the middleware will be described by referring to FIG. 3. As shown in FIG. 3, the middleware application program interface 210 is a programming interface API provided for an application program, and provides a programming interface for an application program, and performs acquisition of data information through the AV stream channel 230, DSMCC DC/OC unit 240 and data channel 290. The application program downloading unit 220 downloads application program files and data, analyzes AIT information from the AIT table buffering unit 250, and downloads the application program and relevant data files thereof through the DSMCC DC/OC unit 240 or the IP network based application program downloading unit 280. the AV stream channel 230 is a channel for transmitting AV stream data and information on the DVB. The DSMCC DC/OC unit 240 is a unit for downloading the application program files and data based on the DVB network, and uses the data broadcasting protocol DSMCC DC/OC of the DVB network. The AIT table buffering unit 250 buffers the application program description information from the DVB network (which may be used as a first network) and the IP network (which may be used as a second network). The application program description information converting unit 260 converts the application program description information from the IP network into the structure of the AIT table for DVB. The AIT information finding unit 270 is used for retrieving and finding the application program information from both networks. The IP network based application program downloading unit 280 performs a downloading based on the application program URL. The data channel 290 is an IP network based data channel. The application programs and data from the IP network can be transmitted and received through the data channel 290.

In the DVB network environment, the application program information finding unit 270 requests the DVB network to filter the AIT information, and transmits the filtered AIT information to the AIT table buffering unit 250. The AIT table buffering unit 250 stores the AIT information transmitted from the AIT information finding unit 270 locally so that the AIT information may be downloaded and used by the application program downloading unit 220. The application program downloading unit 220 monitors the changes in the AIT table buffering unit 250, and downloads the application program and relevant data files thereof according to specific downloading conditions. The downloading procedure will go through the DVB network based DSMCC DC/OC unit 240, in which the data broadcasting transport protocols such as DSMCC/DC/OC/IP over DVB are used to perform the unidirectional network application program downloading, and it is stored in the local file system of the AIT table buffering unit 250. If the downloaded application program has an auto-start attribute and is stored locally, the middleware may auto-start and run the application program. The started application program may use the DTV middleware application program interface 210 to access the resources of the digital television receiving set-top-box, and may also access the DVB network based AV stream through the AV stream channel 230, so as to achieve the specific functions.

The operations based on the DVB network of the middleware have been described as above. Next, the operations of the digital television middleware for transparently downloading and running an IP based application program in the IP network environment will be described.

As mentioned above, when the AIT information finding unit 270 requests the DVB network 3 to filter the AIT information, it also requests the application program description information to the IP network 4. If the AIT information finding unit 270 receives the application program description information from the IP network 4, the received application program description information is directly transmitted to the application program description information converting unit 260. The application program description information converting unit 260 identifies the application program description information from the AIT information finding unit 270, converts the identified information to description information in the AIT format, and sends the converted description to the AIT table buffering unit 250. The AIT table buffering unit 250 buffers the AIT information from the application program description information converting unit 260 locally for being downloaded and used by the application program downloading unit 220. When the application program downloading unit 220 finds the application program description information in compliance with the conditions in the AIT table buffering unit 250, then it recognizes downloading location information of the application program. If DVB network based downloading location information is found, then the application program and relevant data are downloaded following the aforementioned method. If IP network based downloading location information is found, then the application program and relevant data thereof are downloaded via the IP network by using the download protocols such as HTTP and FTP by the URL based application program downloading unit 280. Further, the downloaded files and data are buffered locally. The middleware may start and run the downloaded application program according to predefined application program starting strategies. The started application program may access the resources and the lower layer network interface of the digital television receiving set-top-box by using the DTV middleware application program interface 210 so as to achieve the specific functions.

According to the network digital television middleware of the present invention, the description information, application programs and relevant data thereof can be transmitted under different network environments. For example, the AIT application program description information can be transmitted in the DVB network environment, and the downloading location information of the application program directs to the IP based network system, vise versa. Additionally, no matter which method is used for the download of the application program, it can transparently communicate by using the DVB network and/or the IP network, for example, playing back AV code stream, interacting with the server end or other users, only if the network interface supports the communication.

For making the application program description information converting unit 260 compliable with the information describing the application program transmitted on the IP network, the transport protocol descriptor (MHP 1.1.1, see ETSI TS 101 812V1.2.1) needs to be extended. That is, the data troll descriptor and the interaction channel descriptor need to be extended and are compliable with the original descriptors. It should be noted that the present invention is not limited hereto, but can also be applied to other transport protocol descriptors.

Table 1 gives the transport protocol descriptors.

TABLE 1
Syntax of Transport Protocol Descriptor

| | | |
|---|---|---|
| Syntax | Bit | Mnemonic Symbol |

Transport_protocol_descriptor( ) {

| | | |
|---|---|---|
| descriptor_tag | 8 | uimsbf |
| descriptor_length | 8 | uimsbf |
| protocol_id | 16 | uimsbf |
| transport_protocol_label | 8 | uimsbf |
| for(i=0; i<N; i++) { | | |

| | | |
|---|---|---|
| selector_byte | 8 | uimsbf |

}

}

in which the respective fields are defined as follows:
descriptor_tag: a 8-bit integer field, having a value of 0x02, representing that this field is a transport protocol descriptor;
protocol_id (transport protocol identifier): a 16-bit field, representing an identifier of a transport protocol used in the transmission.

Table 2 gives the values of protocol_id as follow.

TABLE 2
Transport Protocol ID

| protocol_id | Description |
|---|---|
| 0x0000 | Reserved |

| | |
|---|---|
| 0x0001 | Object troll |

| | |
|---|---|
| 0x0002 | IP over DVB |

| | |
|---|---|
| 0x0003 | Data troll (newly added) |
| 0x0004 | IP based interactive channel (newly added) |

| | |
|---|---|
| 0x0005-0x00FF | Reserved for usage |

transport_protocol_labl: omissible.
selector_byte (transport protocol detailed contents): a 8-bit field for complementing protocol specified information. When the protocol_id has a value of 0x0001 or 0x0002, the information of the field has been defined in the standard, and thus it is omitted herein.

Form above Table 2, the present invention adds a value for describing the data troll manner and a value for describing the IP based interactive channel manner in the protocol_id filed representing the transport protocol identifier used in the transmission.

Next, the definition examples of the selector_byte field in a case of data troll will be described. It should be noted that the present invention is not limited hereto.

When the protocol_id has a value of 0x0003, it is in the data troll manner. Table 3 gives the syntax structure of the selector_byte field in the transmission descriptor at this time.

TABLE 3
Syntax of Selector_Byte Transmitted by DC

| Syntax | Bit | Mnemonic Symbol |
|---|---|---|
| remote_connection | 1 | bslbf |
| reserved_future_use | 7 | bslbf |
| if( remote_connection == “1” ) { | | |

| | | |
|---|---|---|
| original_network_id | 16 | uimsbf |
| transport_stream_id | 16 | uimsbf |
| service_id | 16 | uimsbf |

| | | |
|---|---|---|
| } | | |
| component_tag | 8 | uimsbf |

The respective fields in the syntax structure shown in Table 3 have the following meanings respectively.

component tag: a 8-bit field, indicating main service components to which the transmission is applied, and the indicated components forms a basic stream carrying DSI of data troll;
remote_connection: if the transmission connection is not provided by a service carrying the AIT table but by other services, then it has a value of 1. At that time, the subsequent 3 fields, i.e., original_network_id, transport_stream_id, service_id, should be contained in the selector_byte. If the transmission connection is provided the service carrying the current AIT table, then it has a value of 0.

The receiver can not automatically start such an application, but may start it by listing the application's API (restricted by the application descriptor's visibility). Thus, the application can be started by selecting services, but it is not the case to start the API by the application. For the application program having this tag, the application control coder thereof shall be set as REMOTE.

original_network_id: a 16-bit field, indicating an original network ID in transport stream service information (SI) providing the transmission connection.
transport_stream_id: a 16-bit field, indicating an MPEG transport stream ID of a transport stream providing the transmission connection.
service_id: a 16-bit field, indicating a service ID in service information Si providing the transmission connection.

Next, the definition examples of the selector_byte field are given in the IP based interaction channel manner when the protocol_id has a value of 0x0004. It should be noted that the present invention is not limited hereto.

When the protocol_id has a value of 0x0004, the syntax structure of the selector_byte field in the transmission descriptor is shown in Table 4.

TABLE 4
Syntax of Selector_Byte Transmitted by IP Interaction Channel

| Syntax | Bit | Mnemonic Symbol |
|---|---|---|
| alignment_indicator | 1 | bslbf |
| reserved_future_use | 7 | bslbf |
| for( i=0; i<N; i++){ | | |

| | | |
|---|---|---|
| URL_length | 8 | uimsbf |
| for(j=0; j<URL_length; j++){ | | |
| URL_byte | 8 | uimsbf |
| } | | |

}

The respective fields in the syntax structure shown in Table 4 have the following meanings respectively.

alignment_indicator: a 1-bit field, indicating an alignment between a data packet portion and a transport stream byte;
URL_length: a 8-bit field, indicating the number of bytes in the URL;
URL_byte: a 8-bit field, indicating one byte in the Uniform Resource Locator URL and being compliant with RFC2396.

Next, procedures of the digital television middleware according to the present invention for finding and downloading a DVB network based application program and an IP network based application program will be described by way of examples. The finding and downloading of a DVB network based application program is a standard procedure as mentioned above, and thus the detailed description thereof is omitted.

Here, the procedure of finding and downloading the IP network based application program is described. For example, one multicast group is added in a set-top-box having the IPTV middleware according to the present invention. In the multicast group, another member (for example, an application program provider) sends a message which contains the following information:

### Name: RacingCar

Downloading Address: ftp://ftp.game.com/RacingCar

In this case, the set-top-box finds the application program in accordance with following process. Firstly, after receiving the relevant message contained in the multicast group, the set-top-box sends the message to the AIT information finding unit 270 of the IPTV middleware. Thereafter, the message is provided to the application program description information converting unit 260 which converts the IP network based application program description information into the application program description information capable to be used by the DVB network and newly generates a piece of AIT information. For example, the application program name descriptor is RacingCar; the transport protocol identifier protocol_id in the transport protocol descriptor has a value of 0x0004 to indicate that the application program is in the IP network based interaction channel manner; the URL_length in the selector_byte indicates a length of the downloading address; the URL_byte is a character string of “ftp://ftp.game.com/RacingCar” to indicate the downloading address of the application program. After generating the AIT information of the application program, the application program description information converting unit 260 sends the newly generated AIT information to the AIT table buffering unit 250.

When the application program is to be downloaded, the application program downloading unit 220 retrieves and downloads the AIT information buffered in the AIT table buffering unit 250 to find the newly generated AIT information. Next, the application program downloading unit 220 determines that the application program is in the IP based interaction channel manner by analyzing the protocol_id field in the newly generated information, and thus notifies the IP network based application program downloading unit 280 of this message. The application program downloading unit 280 determines that the application program shall be downloaded according to, for example, FTP manner by analyzing the selector_byte in the message. Then, the application program is downloaded by FTP. As an example, the IP network based application program downloading unit 280 may download the application program based on the URL.

After completely downloading the application program, the user may run the application program by activating the application program. Alternatively, the application program may be activated and run by the middleware itself (for example, in an AutoStart manner). After running the application program, the bidirectional interaction may performed with other users or the servers through the data channel 290 and thus in the IP manner. Additionally, after running the application program, the AV code stream programs transmitted via the channel 230 can be played, or other data files or messages required by the application can be downloaded by the unit 240 using the DSMCC protocol.

The digital television middleware according to the present invention may support the application program description information and application program downloading from both the DVB network and the IP network. On the basis of the existing DVB network, for the application program description information from the IP network, it can be firstly converted into a standard storage mechanism of AIT table and then can be buffered. In a hybrid network combining both the IP network and the DVB network, the description information for digital interactive contents is received, converted into the application information table inside the middleware, and then buffered so as to implement the digital video interactive system.

Although the present invention is illustrated with reference to the preferred embodiments thereof, it can be understood by those skilled in the art that various changes, substitutions and modifications to the present invention are possible without departing from the spirit and scope of the present invention. Therefore, the present invention is not limited to the above embodiments but only limited by the following claims and the equivalents thereof.

1. A digital television middleware, comprising:
an application program description information finding unit for requesting application program description information from a first network and a second network;
an application program description information converting unit for converting the received application program description information for the second network into description information in a format of an application program information table (AIT) which can be used by the first network; and
an AIT table buffering unit for buffering the converted description information so as to download the requested application program description information for the second network to be used by the first network.

2. The digital television middleware according to claim 1, further comprising a second network based application program downloading unit for downloading the application program and relevant data thereof via said second network.

3. The digital television middleware according to claim 1, further comprising an application program downloading unit for monitoring the changes in the AIT table buffering unit and for downloading the application program and relevant data thereof in compliance with specific conditions.

4. The digital television middleware according to claim 1, wherein said application program description information converting unit converts the application program description information from said second network into a format of AIT table already existing in said first network so as to be used in the first network.

5. The digital television middleware according to claim 1, further comprising a data channel for the first network for transporting data from the second network to be used by the application program.

6. The digital television middleware according to claim 1, further comprising an audio and video stream transport channel for transporting an audio and video stream transmitted on the first network.

7. The digital television middleware according to claim 1, further comprising a first network based downloading unit for downloading the application program files and data by using first network based data broadcasting protocols.

8. The digital television middleware according to claim 1, further comprising a digital television middleware application program interface for accessing resources and a lower layer network interface of a digital television receiving set-top-box.

9. The digital television middleware according to claim 1, wherein said first network is a digital video broadcasting network.

10. The digital television middleware according to claim 1, wherein said second network is an IP network.

11. A method for interacting in a digital television network combining a first network and a second network, comprising steps of:
receiving a message contained in a multicast group, and providing said message to an application program description information finding unit in a digital television middleware;
converting by an application program description information converting unit, application program description information based on the second network into application program description information capable to be used by the first network, and newly generating a piece of application program description information (AIT); and
storing the newly generated application program description information into an AIT table buffering unit.

12. The method according to claim 11, further comprising steps of: when the application program downloading unit finds the newly generated AIT information, judging a network for which the application program is applied by analyzing a transport protocol identifier filed contained in said newly generated information, and thereby determining an interaction channel manner.

13. The method according to claim 12, further comprising steps of: according to the judged network for which the application program is applied, notifying a corresponding downloading unit; and determining a downloading manner of the application program by analyzing a transport protocol detailed content field contained in the message.

14. The method according to claim 13, further comprising the step of performing a bidirectional interaction with other users or servers via a data channel and in a corresponding manner after running the application program.

15. The method according to claim 11, wherein said first network is a digital video broadcasting network.

16. The method according to claim 11, wherein said second network is an IP network.

17. A set-top-box for a digital television, including the middleware according to claim 1.

18. A digital television system including at least one computer processing element and middleware configured to control the at least one processing element, the system comprising:
an application program description information finding processing element for requesting application program description information from a first network and a second network;
an application program description information converting processing element for converting the received application program description information for the second network into description information in a format of an application program information table (AIT) which can be used by the first network; and
an AIT table buffering processing element for buffering the converted description information so as to download the requested application program description information for the second network to be used by the first network.
